(19) United States
(12) Patent Application Publication
(10) Pub. No.: US 2013/0203940 A1
(43) Pub. Date: Aug. 8, 2013

(54) PREPARATION OF STYRENE BUTADIENE RUBBER MASTERBATCH USING POLYAMIDE AND AN EPOXIDIZED SILICA

(71) Applicant: Jorge Soto, Baton Rouge, LA (US)

(72) Inventor: Jorge Soto, Baton Rouge, LA (US)

(73) Assignee: LION COPOLYMER, LLC, Baton Rouge, LA (US)

(21) Appl. No.: 13/594,645

(22) Filed: Aug. 24, 2012

Related U.S. Application Data
(60) Provisional application No. 61/594,259, filed on Feb. 2, 2012.

(51) Int. Cl. C08L 9/08; C07F 7/10; C07F 7/02

(52) U.S. Cl. 525/102; 549/215; 556/413

(57) ABSTRACT

A functionalized silica for incorporation into natural and synthetic polymers in latex form using precipitated or fumed silica with at least two organosilicon coupling compounds in an aqueous suspension to allow polyamide to load into the polymer latex or to allow polyurethane to load into the polymer latex without disturbing silica-polymer bonds. Polymer-silica reinforced masterbatches are prepared by addition of the functionalized silica slurry using the formed functionalized silica having two different silanes, one for coupling to polyamide or polyurethane and the polymer, the other for connecting directly to the polymer.

### CROSS REFERENCE TO RELATED APPLICATIONS

The present application claims priority to and the benefit of U.S. Provisional Patent Application Ser. No. 61/594,259 filed on Feb. 2, 2012, entitled “FUNCTIONALIZED SILICA FOR RUBBER MASTERBATCH.” This reference is hereby incorporated in its entirety.

### FIELD

The present embodiments generally relate to a preparation of a styrene butadiene rubber masterbatch with an epoxy silane functionalized silica to improve bonding with a polyamide or a polyurethane in a latex process.

### BACKGROUND

This invention relates to an improved process for the manufacture of silica-filled master batches of natural and synthetic rubber and thermoplastic polymers, wherein the silica has been pretreated with two different silanes, a first silane that binds to the natural or synthetic rubber, and at least one second silane that binds to a polyurethane or a polyamide wherein the reaction occurs using an emulsion polymerization processes.

A need has existed for an improved process for the uniform incorporation of a silence functionalized silica slurry into blends of styrene butadiene that has been blended with either a polyamide for improved wear or a polyurethane for improved gripping or both but in prior experiments, such blending of silica into styrene butadiene with polyamide and polyurethane has results in a polymer that falls apart, and is crumbly.

A need has existed for a styrene butadiene rubber which can accept in the latex stage, polyamide and/or polyurethane and fillers of silica.

Silica is a reinforcing agent for rubber and thermoplastic polymers.

A number of techniques have been developed to incorporate reinforcing agents and fillers into the polymer compositions, including both wet and dry blending processes.

The incorporation of silica into styrene butadiene rubber as a reinforcing agent and/or filler is far more complex than might otherwise appear. One problem in wet blending of silica with water-based lattices of such polymers arises from the fact that the hydrophilic silica has a tendency to associate with the aqueous phase and not blend uniformly with the hydrophobic polymer.

Perhaps the most commonly employed practice, used commercially, is the technique of dry blending silica into rubber and thermoplastic polymers in a high-shear mixing operation. This dry blending practice has many limitations. Notable among them includes the tendency of the filler particles, the silica, to agglomerate that is, stick to each other, resulting in a non-uniform dispersion of the filler throughout the polymer constituting the continuous phase.

Another problem commonly experienced in such dry formulation high-shear operations is the tendency of the polymers to degrade, or break down, during processing. The degradation necessitates the use of higher molecular weight polymers, which sometimes require the incorporation of various types of processing aids to facilitate mixing and dispersion of the filler particles into the polymer constituting the continuous phase. The cost associated with the use of such processing aids increases the manufacturing cost of the polymeric compound or article. The use of processing aids may increase the length of time needed for processing. The use of processing aids has the further disadvantage in that such processing aids may have a negative effect on the cure or end use of the polymer, changing the characteristics of the styrene butadiene rubber or similar thermoplastic rubber. Dry blending also has a negative effect in that some fillers can cause additional processing costs due to excessive equipment wear caused by the abrasive fillers.

To improve dispersion of the silica through the polymer matrix during dry mixing, the invention proposes treating the silica with two different organosilane coupling agents.

There is a need to provide a simple and less expensive technique for the uniform incorporation of silica into natural and synthetic polymers which do not require the use of complex processing aids and which enable polyamides to be uniformly incorporated and bonded into the polymer matrix or which enable polyurethanes to be uniformly incorporated and bonded covalently into the polymer matrix such as the latex of styrene butadiene rubber.

There is a need to provide a process that allows for the incorporation of silica into natural or synthetic polymers during the latex stage that overcomes the foregoing disadvantages.

There is a need to provide a process for the incorporation of compatibilized silica with a polyamide or a polyurethane into natural and synthetic polymers at the latex stage which is simple and inexpensive and can be used without causing premature coagulation of the latex and which additionally facilitates the mixing of a polyamide or a polyurethane into the rubber or polymer latex.

The present embodiments meet these needs.

### BRIEF DESCRIPTION OF THE DRAWINGS

N/A

### DETAILED DESCRIPTION OF THE EMBODIMENTS

Before explaining the present process in detail, it is to be understood that the process is not limited to the particular embodiments and that it can be practiced or carried out in various ways.

The process uses silica which has been precipitated or fumed in an aqueous suspension, adds a first silane coupling agent that bonds to the silica and also to a natural or synthetic polymer and a second silane that bonds to the silica and to a polyamide or a polyurethane as a functionalized silica slurry.

The functionalized silica slurry is used to simultaneously covalently bond the silica to the polyamide or polyurethane while the silica is also bonded to the natural rubber or synthetic polymer thereby forming a reaction product wherein only the silica is bonded to the fillers, thereby keeping the rubber to rubber interactions strong while providing the properties of the polyamide or the polyurethane to the final formulation which enables the formulation to resist forming a crumbly polymer or crumb rubber.

The functionalized silica slurry can be blended with the natural or synthetic polymer latex at a low temperature.

The process can involve first forming a functionalized silica with two different silanes formed on the silica surface. In embodiments, the silanes are substantially uniformly distributed through the polymer latex. The process is advantageous in that the silanes are selected because they do not alter the physical state of the polymer/rubber particles in the latex, thus permitting the incorporation into the latex, of a polyamide or a polyurethane.

Upon low temperature heating, the silica can be incorporated into and adheres to the polymer and the polyamide after coagulating the latex. The use of low temperature is another advantage, in that less energy is needed to form the functionalized silica than other processes.

The silica becomes substantially uniformly distributed throughout the polymer particles with the polyamide or polyurethane allowing the polymer rubber (such as a styrene butadiene rubber matrix) to be filled with the polyamide or the polyurethane using covalent bonds.

The polyamide, the polyurethane, and the silica do not dilute the final formulation rubber properties for scorch, for durometer or brittleness but add polyamide physical characteristics or add polyurethane material properties to the rubber, while preventing the rubber from forming a crumb.

The amount of polyamide and the amount of polyurethane used in the rubber can be as high as 50 weight percent based on the total formulation.

The heating of the latex with the treated silica, polyamide or polyurethane in an embodiment is no more than 30 degrees Celsius for 24 hours to create the complete reaction product.

The process can be used with any natural or synthetic polymer made into latex form and is safer to perform than higher temperature latex processes or processes that involve vulcanization. The process reduces the cost of the polymer while synergistically providing enhanced physical properties to the rubber by adding the polyamide or the polyurethane to the matrix of the latex.

The process is suited for natural and synthetic rubber lattices and for incorporation into a continuous or batch emulsion polymerization process at the latex stage.

A benefit of this invention is that the new processes increases the fill of the rubber matrix with the silica and the polyamide or polyurethane while providing advantageous characteristics of stiffness of the polyamide or the flexibility of the polyurethane in a final rubber formulation, such as a styrene-butadiene rubber formulation.

A benefit of this invention is that by using polyamide or polyurethane with the silica, a rubber can be produced which is anticipated to have improved rolling resistance, such as a 8 percent to 10 percent improved rolling resistance, as measured by tangent delta at 60 degrees Celsius.

A benefit of this invention is that tensile strength of a final rubber formulation is expected to exhibit improved characteristics by using polyamide with the silica simultaneously in the latex.

Still another benefit of this invention is that the final formulation should exhibit improved elongation of the resultant polymeric rubber by about 5 percent with the added polyurethane simultaneously added with the silica to the latex.

Even though the silica can be pretreated in sequence with the two different silanes in an embodiment, the silica can be pretreated using the two different silane coupling agents simultaneously, and then the formed functionalized silica can be added to the latex simultaneously with the polyamide or polyurethane for a resultant rubber formulation usable in tires that should provide a miles per gallon of 35 or better.

By using silica with two different silanes, one that couples to the polyamide or the polyurethane and one that couples to the polymer rubber (such as styrene-butadiene rubber (SBR), it is expected that the final rubber formulation will be more resilient, due to both (i) a reduction in sulfur in the overall rubber formulation which enhances life of tires made with the rubber (because the two different silanes together, and synergistically inhibit sulfur attachment to the silica), and (ii) production of two different structural properties, such as reduced degradation at elevated temperatures based on the use of the polyamide with the treated silica and improved resistant to brittleness based on the use of the polyurethane.

Another benefit from use of the two different silanes to enhance loading of polyamide into the final rubber formulation to provide a lower Mooney viscosity for the final rubber than without the using a silica modified with two different silanes. It is expected that the Mooney viscosity will be reduced by about 5 percent over formulations that contain only one silane coupling agent or for formulation without polyamide incorporated into the latex.

It is expected with the process, that the final rubber formulation will exhibit a lower processability cost by producing a formulation capable of being formed into articles with reduced heating times and curing times by improving compatibilization between the silica and the rubber and using the polyamide to have a different, second melting point creating a stronger material by having two different melting points in the formulation.

Still another benefit of the invention is the process teaches the production of a unique masterbatch with reduced scorch for the final rubber formulation. It is expected that the scorch of the final rubber formulation will be reduced by at least 2 percent with the addition of the polyamide to the SBR latex.

The term “functionalized silica slurry” can be used herein to refer to an aqueous suspension of silica with some of its reactive sites rendered hydrophobic via a reaction with at least two coupling agents. The hydrophobic portion of each coupling agents is being compatible with the natural or synthetic polymer to which the silica is blended forming a rubber resistant to easy degradation.

The term “coupling agent” can refer to a coupling agent directly soluble in water or soluble in water with the aid of a co-solvent.

### Creating the Functionalized Silica

The coupling agent or agents as used herein refers to two different silanes, each with a functional group having the capability of chemically reacting with the surface of the silica to bond the silane to the silica.

Each of the two different silane coupling agents has a functional group capable of compatibilizing with the natural or synthetic polymer into which the silica will be filled, joining the silica to the polymer or natural rubber, such as styrene butadiene rubber.

In embodiments, the coupling agents include a functional group having the capability of reaction with a rubbery polymer or a thermoplastic polymer during the cure or compounding thereof, to chemically bind the coupling agent to the polymer.

If two coupling agents are used, both can have either a methoxy group, as mono, di or trimethoxy groups. Once each coupling agent is anchored to a silica site, one of the coupling agents reacts with mercapto groups and the other coupling agent reacts with amino groups or an epoxy resin.

The coupling agent serves to promote a chemical bonding relationship between the silica surface and compatibilization of natural or synthetic polymers with the polyamide or epoxy in the latex depending on which one is used.

In the case of cross-linkable, curable polymers the coupling agents can serve to promote a chemical bonding relationship between both the silica surface and the cross-linked, cured polymer.

In one or more embodiments, at least 0.1 weight percent to 25 weight percent of at least one silane coupling agent is added to the silica, based on the total weight percent of the silica with silane coupling agent. If two silane coupling agents are used, then the two silane coupling agents are blended together first and the total amount of the blended silanes can be from 0.1 weight percent to 25 weight percent of the silica. In this embodiment, the silicas have been functionalized with the silanes and the treated silica is added to the polymer latex containing the polyamide or epoxy component.

The silane coupling agent can be an organosilicon derived from an organic silane having the structure: Z₁Z₂Z₃Si(CH₂)_{y}X(CH₂)_{y}SIZ₁Z₂Z₃, wherein X is a polysulfide, wherein Y is an integer equal to or greater than 1; and wherein Z₁, Z₂, and Z₃ are each independently selected from the group consisting of hydrogen, alkoxy, halogen, and hydroxyl.

Alternatively, the silane coupling agent can be an organosilane an organosilicon derived from an organic silane having the structure

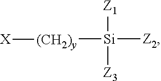

wherein:
(a) X is a functional mercapto group;
(b) Y is an integer equal to or greater than 0; and
(c) Z₁, Z₂, and Z₃ are each independently selected from the group consisting of hydrogen, alkoxy, halogen, and hydroxyl, and combinations thereof; or

In embodiments, combinations of two first silanes described above can be used wherein the organosilicons are present as an average tetrameric structure having a T.sup.3/T.sup.2 ratio of 0.75 or greater as measured by NMR.

One or two of the first two silanes described above can be blended with a second silane coupling agent for compatibilizing with the polyamide or the polyurethane. The second silane consisting of an organosilane an organosilicon derived from an organic

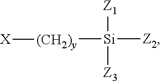

silane having the structure wherein:
(a) X is a functional group selected from the group consisting of: an amino group, a polyamino alkyl group, a thiocyanato group, an epoxy group, or a halogen;
(b) Y is an integer equal to or greater than 0; and
(c) Z₁, Z₂, and Z₃ are each independently selected from the group consisting of hydrogen, alkoxy, halogen, and hydroxyl, and combinations thereof,
(d) wherein the first and second silane coupling agents have a T.sup.3/T.sup.2 ratio of 0.75 or greater as measured by NMR; and the blend of the silica and silanes form the functionalized silica.

Each silane coupling agent is derived from an organosilane having three readily hydrolyzable groups attached directly to a silicon atom of the organosilane, and at least one organic group attaches directly to the silicon atom.

In embodiments, the T.sup.3/T.sup.2 ratio is 0.9 or greater.

In still other embodiment, the total amount of the organosilicons bound to the surface of the silica is present in amounts from 2 weight percent to 14 weight percent based on the total weight of the silica.

For example, the silica is first isolated and dried resulting in a partly hydrophobic silica. The silica is then blended with the silane coupling agents forming a functionalized silica having coupling agents chemically bonded to its surface. This functionalized silica can then be used in dry blending operations or reslurried for use as an aqueous suspension.

It has been found that the concepts of the present embodiments serve to substantially uniformly disperse the functionalized silica throughout the polymer latex with the polyamide, preventing clustering of the polyamide.

The embodiments allows the treated silica to be uniformly and quantitatively dispersed into the polymer once the latex has been coagulated allowing the silica and the polyamide to serve as a strong reinforcing agents with less crumbling than polymers without the treated silica and polyamide.

The concepts of the process are applicable to a variety of natural and synthetic polymers including particularly rubber and thermoplastic polymers made in latex form.

In one or more embodiments, a silica is first treated with at least one coupling agents in an aqueous solution to form a functionalized silica slurry.

As the functionalized silica employed in the practice of the embodiments, use can be made of a number of commercially available amorphous silicas of either the precipitated or fumed type having finely divided particle sizes and high surface area.

The size of the silica particles can be varied within relatively wide ranges, depending somewhat on the end use of the silica-filled or silica-reinforced polymer.

In general, use is made of silica having average particle sizes ranging from 1 nm to 120 nm and corresponding surface areas of 15-700 m.sup.2/g.

The finely divided amorphous silica is thus formed into an aqueous slurry and treated with a solution of one or more coupling agents which chemically bind to sites on the silica surface.

In general, such silicon compounds contain at least one, but no more than three, readily hydrolyzable groups bonded directly to the silicon atom.

Representative of the hydrolyzable groups commonly employed in such coupling agents can be halogens, hydrogen, hydroxyl, lower alkoxy groups such as methoxy, ethoxy, propoxy and like groups.

Also attached directly to the silicon atom are one to three organic groups compatible with the natural or synthetic polymer to which the silica is to be added. In one or more embodiments, the coupling agent can have at least one organic group containing a functional group capable of chemical reaction with the natural or synthetic polymer to which the silica is to be added. Such functional groups include but are not limited to amine groups, polyamino alkyl groups, mercapto groups, carbonyl groups, hydroxy groups, epoxy groups, halogens and ethylenically unsaturated groups.

The choice of functional group will be determined by the particular polymer and the particular method of fabrication of the polymer-silica masterbatch. For example, if this process is applied to a styrene-butadiene rubber to provide a silica masterbatch which will be cured via cross-linking reactions involving sulfur compounds. In one or more embodiments, organosilicon compounds can be utilized as the two coupling agents, wherein at least one organic group has mercapto, polysulfide, thiocyanato (—SCN), a halogen and/or amino functionality. Correspondingly, if the silica filled polymer is to undergo a peroxy type of curing reaction, it is desirable to have as one of the two organosilicon compounds, at least one organic group with ethylenic unsaturation or epoxy groups.

Representative of coupling agents imparting compatibilization to the natural and synthetic polymers are those from the groups consisting of trialkylsilanes, dialkylsilanes, trialkylalkoxysilanes, trialkylhalosilanes, dialkyalkoxysilanes, dialkyldialkoxysilanes, dialkylalkoxyhalosilanes, trialkylsilanols, alkyltrialkoxysilanes, alkyldialkoxysilanes, alkyldialkoxyhalosilanes, and monoalkylsilanes wherein the alkyl group is a C.sub.1 to C.sub.18 linear, cyclic, or branched hydrocarbon or combinations thereof, and wherein for some particular embodiments one or two alkyl groups can be replaced with a phenyl or benzyl group or one to two alkyl groups can be replaced with a phenyl, benzyl, or alkoxy substituted alkyl group.

In one or more embodiments, the coupling agents which can be used in the practice of the process are the bispolysulfides. These organosilicon compounds can be described as bis(trialkoxysilylalkyl)polysulfides containing 2 sulfur atoms to 8 sulfur atoms in which the alkyl groups are C.sub.1-C.sub.18 alkyl groups and the alkoxy groups are C.sub.1-C.sub.8 alkoxy groups.

Representative of such coupling agents which are commercially available include (gamma-aminopropyl)trimethoxysilane, (gamma-aminopropyl)triethoxysilane, (gamma-hydroxypropyl)tripropoxysilane, (gamma-mercaptopropyl)triethoxysilane, (gamma-aminopropyl)dimethylethoxysilane, (gamma-aminopropyl)dihydroxymethoxy-silane, (glycidylpropyl(trimethoxysilane, [(N-aminoethyl)gamma-aminopropyl]-triethoxysilane, (gamma-methacryloxy-propyl)triethoxysilane, (gamma-methacryoxy-propyl)trimethoxysilane, (beta-mercaptoethyl)triethoxysilane, [gamma-(N-aminoethyl)propyl]trimethoxysilane, N-methylaminopropyltrimethoxysilane, (gamma-thiocyanatopropyl)triethoxysilane, bis-(3-triethoxythiopropyl)tetrasulfide, vinyltriethoxysilane, vinylphenylmethylsilane, vinyldimethylmethoxysilane, divinyldimethoxysilane, divinylethyldimethoxysilane, dimethylvinylchlorosilane, and the like.

In carrying out the reaction between coupling agents, such as organosilanes, and the silica, the coupling agents can be dissolved in a lower alkanol such as propanol or ethanol at a pH below 9 to which water is slowly added, either continuously or incrementally, to commence hydrolysis of the hydrolyzable groups contained in the coupling agents to form the corresponding silanol. To assist in the hydrolysis of an alkoxy group, a pH in the range of 3.5-5.0 is desirable to minimize side reactions such as oligomerization of the organosilane, and can be maintained by use of dilute mineral acid such as hydrochloric or weak organic acids such as acetic acid. To assist in the hydrolysis of a hydride group more alkaline conditions and bases such as KOH, NaOH, NH.sub.4 OH, triethylamine, or pyridine can be employed to maintain a pH of 8-9. The choice of base will be dependent on the chemical nature of the specific latex to which the silica slurry is added.

When the hydrolyzable group is halogen, the organohalo-silane can be mixed directly with the aqueous silica dispersion rather than carrying out a separate hydrolysis step. The hydrolyzed coupling agent is then blended with an aqueous slurry of the finely divided silica whereby the silanol groups present in the coupling agent chemically react with the surface of the silica to form a siloxane bond (Si—O—Si) between the coupling agent and the silica surface. In one or more embodiments, the pH at this step is maintained at approximately 5.5-6.5 to favor reaction with the silica surface while allowing some condensation reaction between the silane molecules bonding to the surface of the silica. Depending on the particular silica and the initial pH of the water, this pH is attained without addition of further reagents.

The concentration of the silica in the slurry with which the hydrolyzed coupling agents is blended can be varied within relatively wide limits.

In general, use can be made of silica slurries containing from 1 weight percent to 30 weight percent silica based on the weight of the slurry. In one or more embodiments, the slurry concentration can range from 10 weight percent to 20 weight percent silica based on the weight of the slurry. Temperature and reaction time can be varied within wide limits. In general, temperatures ranging from ambient up to about 200 degrees Fahrenheit can be used. Similarly, the time for effecting the reaction between the hydrolyzed coupling agent and the silica can be varied within relatively wide limits, generally ranging from 4 hours to 48 hours, depending somewhat on the temperature employed.

The amount of the coupling agents employed can likewise be varied within relatively wide limits, depending in part on the amount of silica to be blended with the natural or synthetic polymer and the molecular weight of the coupling agent. Use can be made of coupling agents, wherein the total amount of the at least two coupling agents is within the range of 1 part to 25 parts of coupling agents per 100 parts by weight of silica.

The amount of coupling agents to be used can be defined in terms of the actual weight percent of organosilicon residing on the silica surface.

It has been found that to achieve greater than 90 percent by weight silica incorporation into a polymer, the weight percent of organosilicon on the surface of the silica must be in the range of at least 1.0-2.5, that is, a minimum of 1.0-2.5 grams of organosilicon from the silane is bound to 100 grams of silica charged to the slurry. For enhanced compatibility in dry mix or for additional chemical reaction with the natural or synthetic polymers, it may be desirable to bind greater than 2 percent by weight.

### Usable Polymers and Monomers

Typical of the synthetic polymers useful in the practice of the present embodiments are those prepared by polymerizing or copolymerizing conjugated diene monomers such as butadiene, isoprene, chloroprene, pentadiene, dimethylbutadiene and the like. It is also possible to apply the concepts of the embodiments to other polymers made in latex form including, not only conjugated diene-based polymers, but also polymers based on vinyl monomers and combinations of conjugated dienes with vinyl monomers and mixtures thereof.

Suitable vinyl monomers can include but are not limited to styrene, alpha-methylstyrene, alkyl substituted styrenes, vinyl toluene, divinylbenzene, acrylonitrile, vinyl chloride, methacrylonitrile, isobutylene, maleic anhydride, acrylic esters and acids, methylacrylic esters, vinyl ethers, vinyl pyridines and the like and mixtures thereof.

Specific polymers are exemplified by natural rubber, styrene-butadiene rubber or SBR, acrylonitrile-butadiene rubber or NBR, acrylonitrile-butadiene-styrene polymer or ABS, polybutadienes, polyvinylchloride or PVC, polystyrene, polyvinyl acetate, butadiene-vinyl pyridine polymers, polyisoprenes, polychloroprene, neoprene, styrene-acrylonitrile copolymer (SAN), blends of acrylonitrile-butadiene rubber with polyvinylchloride, and mixtures thereof.

### Emulsion Polymerization

The process can be carried out with these polymers in their latex form and is particularly suited for application to natural rubber lattices and as polymerized lattices.

“Emulsion polymerization” as the term is used herein can refer to the reaction mixture prior to the coagulation stage of the emulsion process.

The treated silica can be added as a dry component or as a wet component to the latex.

In addition to the polymers already recited the functionalized silica can be blended with polyolefins, and poly-alpha-olefins, polyesters, polycarbonates, polyphenylene oxides, polyepoxides, polyacrylates, and copolymers of acrylates and vinyl monomers. Synthetic polyolefins include homopolymers, copolymers, and other comonomer combinations prepared from straight chain, branched, or cyclic-alpha-monoolefins, vinylidene olefins, and nonconjugated di-and triolefins, including 1,4-pentadienes, 1,4-hexadienes, 1,5-hexadienes, dicyclopentadienes, 1,5-cyclooctadienes, octatrienes, norbornadienes, alkylidene norbornenes, vinyl norbornenes, etc. Examples of such polymers include polyethylenes, polypropylenes, ethylene-propylene copolymers, ethylene-alpha-olefin-nonconjugated diene terpolymers (EPDMs), chlorinated polyethylenes, polybutylene, polybutenes, polynorbornenes, and poly alpha-olefin resins and blends and mixtures thereof.

After the silica has been treated with the coupling agents, the treated silica slurry can then be blended with the natural or synthetic polymer latex with sufficient agitation to uniformly distribute the treated silica throughout the latex.

The silica treated latex is stable and can be fed directly to a coagulation process, where coagulation aids conventional for that type of natural or synthetic polymer are employed.

The stability of the latex will depend, however, on maintaining a proper pH range which is variable with the particular emulsion process. For example, when the emulsion process is a cold SBR process or cold NBR process utilizing anionic surfactant to maintain the pH at 8.0-9.5. However, if the process is a hot carboxylated SBR emulsion process or hot carboxylated NBR emulsion process using cationic surfactants, the pH should be kept from 3.5 to 5.5 to ensure stability of the latex.

The amount of the silica added to the latex can be varied within wide ranges, depending in part on the coupling agents employed, the nature of the polymer, the use of other fillers such as carbon black, and the end use to which that polymer is subjected. In general, good results are obtained where the silica is added in an amount within the range of 5 percent to about 80 percent by weight based upon the weight of the solids in the latex.

During coagulation, the functionalized silica remains dispersed, intimately admixing and adhering to the polymer particles resulting in a substantially uniform distribution of the silica particles within the particles of the polymer. Other processing aids can be added to polymer latex such as plasticizers, extender oils, and antioxidants can be added at the latex stage along with the functionalized silica slurry without modifying equipment and process conditions, or adversely affecting the dispersion of the silica during coagulation and dewatering.

The process provides a significant economic advantage in making rubber tires, in that, once the latex is coagulated to recover the polymer containing the functionalized silica, the residual liquid phase contains only small amounts of the functionalized silica which were not incorporated into the polymer.

The functionalized silica, the partially hydrophobic silica, isolated from the functionalized silica slurry by decantation and drying is characterized as having clusters of organosilicon oligomers on the surface of the silica. This clustering is the result of bonding to the silica surface oligomers of the organosilanes, that is, the organosilane undergoes some condensation reaction with itself to form an oligomeric structure which chemically binds to the silica surface via the Si—O—Si bonds.

The clusters of organosilane oligomers are identified by NMR as stated by M. Pursch, et al. and as disclosed in Anal. Chem. 68, 386 and 4107, 1996. The spectrum was acquired with a 7 mms contact time, 5.0 kHz spinning speed, and a 33 kHz r.f. field on both .sup.1 H and .sup.29 Si. The chemical shift scale is relative to the resonance for tetramethylsilane (TMS) at 0.0 ppm. The assignment of the resonances was made by comparison with previous spectral assignments of silanes bound to silica surfaces as described in Pursch. Two main groups of resonances are seen. The resonances of the silicon atoms on the surface of the silica are represented by the Q sites, Q.sup.2, Q.sup.3, and Q.sup.4 at −93.7 ppm, −102.5 ppm, and −112.0 ppm, respectively. The T sites, T.sup.2 and T.sup.3, at −57.5 and −67.9 ppm respectively, correspond to silicon atoms of the silanes that are chemically bonded to the silica surface.

The different T sites are characterized as to the degree of oligomerization or cross-linking of the silanes on adjacent silicon atoms with each other. That is, a T.sup.1 site represents a silane molecule chemically bonded only to the silica surface. A T.sup.2 site represents a silane molecule chemically bonded to a Si atom on the silica surface and to one adjacent silane or a silane chemically bonded to two adjacent surface Si atoms, i.e. partially cross-linked structures; while a T.sup.3 site represents a silane molecule chemically bonded to a Si atom in the silica surface and to 2 adjacent silanes or a silane chemically bonded to three surface Si atoms, i.e. completely cross-linked structure. Pursch et. al. have used the relationship of the intensity of the T sites to define an extent of oligomerization or cross-linking parameter referred to as parameter Q, and is defined below:

The functionalized silica of this process can have a parameter Q value of greater than 80 percent, while prior art and commercial silane treated silicas measure a Q value of less than 75 percent. The higher Q value for the functionalized silica of this embodiment is due to the greater proportion of T.sup.3 sites, that is, a higher concentration of oligomerized or fully cross-linked silane is present. The functionalized silica of this embodiment can be described as having a T.sup.3/T.sup.2 ratio of 0.75 or greater. Commercial silane coated silica and silica described in prior art publications have T.sup.3/T.sup.2 ratios of 0.6 or less. The higher degree of cross-linking in the silica of this embodiment can be explained as having an average tetrameric structure of silane on the surface in contrast to commercial silica where the average structure ranges from monomeric to trimeric.

While not wishing to be bound by any theory, it is believed that the average tetrameric structure of the silane bound to the silica surface of the functionalized silica is due to the aqueous reaction medium used in its preparation. By controlling the pH of the aqueous phases, hydrolysis and oligomerization reactions can compete with adsorption and chemical reaction of the silanol groups on the silica surface. Thus more organosilane binds to the surface in oligomeric form.

It can be understood that various changes and modifications can be made in the details of formulation, procedure and use. The following examples are provided by way of illustration and not by way of limitation of the practice of the present embodiments.

Chemicals used to demonstrate the concepts of this process can be as follows:

Silquest™ A-189 (gamma-mercapto) propyltrimethoxysilane is a Momentive product.

Hi-Sil™ 233 (PPG) is a precipitated, hydrated amorphous silica in powder form, ultimate particle size of 0.019 microns.

Octyltrimethoxysilane OTES is a Dow Corning™ product Z-6341 with a CAS number 2943-75-1 and a linear formula CH₃(CH₂)₇Si(OC₂H₅)₃ and a molecular weight of 276.49.

Trimethoxy silane is also available from Dow Corning with a CAS number of 2487-90-3 and a molecular formula of C₃H₁₀O₃Si.

Dodecylmethyldiethoxy silane is available from American Custom Chemicals Corporation of San Diego with a CAS number 60317-40-0 and a linear formula C₁₇H₃₈O₂Si and a molecular weight of 302.57302.

Disiloxane, hexamethoxy also known as hexamethoxy silane with a molecular formula: C₆H₁₈O₇Si₂ and a molecular weight of: 258.37392.

“Polyanilines” can be added as an antistatic material with the polyamide or epoxy in an embodiment. The term “polyaniline” as the term is used herein can refer to a conducting polymer of the semi-flexible rod polymer family. Polyaniline can be found in one of three idealized oxidation states: leucoemeraldine—white/clear & colorless (C₆H₄NH)ₙ; emeraldine—green for the emeraldine salt, blue for the emeraldine base ({[C₆H₄NH]₂[C₆H₄N]₂}ₙ) and (per)nigraniline—blue/violet (C₆H₄N)ₙ. Polyaniline is typically produced in the form of long-chain polymer aggregates, surfactant (or dopant) stabilized nanoparticle dispersions, or stabilizer-free nanofiber dispersions depending on the supplier and synthetic route. Polyaniline is commercially available from Ormecon.

“Nanomaterial” can be used with the polyamide or epoxy as an additional filler. As the term is used herein, the term “nanomaterial” can include carbon nanofibers which are vapor grown carbon fibers (VGCFs), or vapor grown carbon nanofibers (VGCNFs) are cylindric nanostructures with graphene layers arranged as stacked cones, cups or plates. Carbon nanofibers with graphene layers wrapped into perfect cylinders are called carbon nanotubes and are a form of nanomaterial as well.

It can be noted that nanomaterial can be added to the latex after the silica is added to enhance structural characteristics of the resultant rubber such as wear, which improves by about 15 percent, and stiffness.

It can be noted that polyaniline can be added to any of the latex after the silica is added to enhance structural characteristics of the resultant rubber, namely to reduce static charge build up on the rubber formed by the latex.

### Example 1

### Compatibilized Silica 1

kilograms of precipitated or fumed Silica with a particle size from 0.1 to 5 microns, and a surface area of 120-250 square meters per gram is charged to a ribbon blender or mixing equipment with a mixing mechanism and then heated from 50 degrees Celsius to 150 degrees Celsius.

As the silica is heated to the desired temperature of 100 degrees Celsius, glacial acetic acid is sprayed evenly over the silica as it tumbles in the mixing equipment. The amount of glacial acetic acid added can be from 0.1 weight percent to 10 weight percent, based on the total amount of the silica.

The mixture obtained as described in the previous paragraph can be continuously stirred and then two silanes are added at the same time: silane1=bis(trimethoxy silyl)propyl-tetrasulfide and silane2=3-(glycidyloxypropyl)triethoxysilane (Gelest Inc). The total amount of the two silanes is such that the sum of silane1+silane2 falls in the range from 1 kilogram to 15 kilograms (2 weight percent to 30 weight percent of the total silica formulation). The addition is done by spraying the silanes onto the mixture in the reactor over a period of 5 minutes to 60 minutes. The silica absorbs the silanes and the acid by incipient absorption or wetness (capillary action).

The continuously stirred mixture is kept at the desired operating temperature of 100 degrees Celsius from 1 hour to 12 hours. This compatibilized silica material is composed of silanes chemically bound to the silica.

The pH of the formed Compatibilized Silica 1, as tested upon suspension of 5 grams of the treated silica in 100 mL of water, is expected to be from 2 to 7.

### Mastererbatch 1:

The Compatibilized Silica 1 made as described in Example 1, can be used to prepare a Masterbatch 1 with styrene-butadiene rubber (SBR).

An example of Masterbatch 1 preparation involves: mixing of 20 kilograms of Compatibilized Silica 1 into 80 kilograms of water (20 weight percent) which is mixed at temperatures from 20 degrees Celsius to 80 degrees Celsius with 100 kilograms of a styrene-butadiene resin (SBR) emulsion which is 10 weight percent to 69 weight percent solids, with a pH from 9 and 12, wherein the composition of SBR has from 5 weight percent to 40 weight percent styrene and the balance being butadiene, from 95 weight percent to 60 weight percent butadiene. This mixture of SBR latex with Compatibilized Silica 1 is coagulated with calcium nitrate in concentration of from 2 weight percent to 20 weight percent with an acid to get a final pH of the mixture of 4.0-4.5. The acid can be a sulfuric acid having a concentration of from 2 weight percent to 30 weight percent until a pH of 4.0-4.5 is reached. The coagulum is then separated with a screen and dried forming a dried Masterbatch 1.

### Extended Masterbatch 1:

To 10 kilograms of the masterbatch 1 from the previous paragraph are added 10 kilograms of a nylon material (polyamide, PA) such as Nylon 6™ from E.I. DuPont of Wilmington, Del., at temperatures ranging from 50 degrees Celsius to 180 degrees Celsius. The mixture is dry blended for 10 minutes to make an Extended Masterbatch 1 which after curing (vulcanization) will have enhanced mechanical properties due to the chemical bonding occurring between the tetrasulfide group of silane1 with those of styrene butadiene rubber on one hand, and the epoxy groups of silane2 and the amino end-groups of the polyamide on the other hand.

This Extended Masterbatch 1 provides a final formulation with improved mechanical properties after curing, over SBR alone, including but not limited to higher tensile strength and higher modulus, as well as improved (lower) compression set.

### Example 2

### Compatibilized Silica 2

50 kilograms of precipitated or fumed Silica with a particle size from 0.1 to 5 microns, and a surface area of 120-250 square meters per gram is charged to a ribbon blender or mixing equipment with a mixing mechanism and then heated from 50 degrees Celsius to 150 degrees Celsius.

As the silica is heated to the desired temperature of 100 degrees Celsius, diethylene triamine (Dow Chemical) is sprayed evenly over the silica as it tumbles in the mixing equipment. The amount of diethylene triamine added can be from 0.1 weight percent to 10 weight percent, based on the total amount of the silica.

The mixture obtained as described in the previous paragraph can be continuously stirred and then two silanes are added at the same time: silane1=bis(trimethoxy silyl)propyl-tetrasulfide and silane3=3-[2-(2-Aminoethylamino)ethylamino]propyl-trimethoxysilane (Gelest, Inc).

The total amount of the two silanes is such that the sum of silane1+silane3 falls in the range from 1 kilogram to 15 kilograms (2 weight percent to 30 weight percent of the total silica formulation).

The addition is done by spraying the silanes onto the mixture in the reactor over a period from 5 minutes to 60 minutes. The silica absorbs the silanes and the acid by incipient absorption or wetness (capillary action).

The continuously stirred mixture is kept at the desired operating temperature of 100 degrees Celsius from 1 hour to 12 hours. This Compatibilized Silica 2 material is composed of silanes chemically bound to the silica.

### Masterbatch 2:

The Compatibilized Silica 2 made as described in Example 2, can be used to prepare a Masterbatch 2 with styrene-butadiene rubber (SBR).

Example of Masterbatch 2 preparation: mixing of 20 kilograms of Compatibilized Silica 2 into 80 kilograms of water (20 weight percent) which is mixed at temperatures from 20 degrees Celsius to 80 degrees Celsius with 100 kilograms of a styrene-butadiene resin (SBR) emulsion which is 10 weight percent to 69 weight percent solids with a pH from 9 to 12, wherein the composition of SBR has from 5 weight percent to 40 weight percent and the balance being butadiene, from 95 weight percent to 60 weight percent butadiene. This mixture of SBR latex with Compatibilized Silica 2 is coagulated with calcium nitrate in concentration of from 2 weight percent to 20 weight percent. The coagulum can then be separated with a screen and dried forming a dried Masterbatch 2.

### Extended Masterbatch 2:

To 10 kilograms of the masterbatch 1 from the previous paragraph are added 10 kilograms of polyurethane such as IROGRAN® E-type from Huntsman Chemicals (Auburn Hills, Mich.) at temperatures from 50 degrees Celsius to 180 degrees Celsius. The mixture is dry blended for 10 minutes to make an Extended Masterbatch 2 which after curing (vulcanization) will have enhanced mechanical properties due to the chemical bonding occurring between the tetrasulfide group of silane1 and the styrene butadiene rubber on one hand, and the amino groups of silane3 with those of the polyurethane on the other hand.

This Extended Masterbatch 1 provides a final formulation with improved mechanical properties after curing, over SBR alone, including but not limited to higher tensile strength and higher modulus, as well as improved (lower) compression set.

In an embodiment the polymer silica masterbatch can include from 5 weight percent to 50 weight percent of a natural rubber or synthetic polymer; from 2 weight percent to 40 weight percent of a functionalized silica, wherein the silane coupling agents are chemically bound to the surface of the silica are present as an average tetrameric structure having a T.sup.3/T.sup.2 ratio of 0.75 or greater as measured by NMR; and a member of the group consisting of: from 5 weight percent to 50 weight percent of a polyamide, such as a dry polyamide or an emulsion (latex) of polyamide; from 5 weight percent to 50 weight percent of a polyurethane, such as a dry polyurethane, an emulsion (latex) of polyurethane, or a mixture of the polyamide and polyurethane, wherein the polyamide to polyurethane is present in the mixture in a ratio between 1:20 polyamide to polyurethane to 20:1 polyamide to polyurethane and wherein the functionalized silica bonds to both the polyamide, the polyurethane, or both while providing strong covalent bonding to the natural or synthetic polymer

In other embodiment, the polymer silica masterbatch can use a functionalized silica having a T.sup.3/T.sup.2 ratio of 0.9 or greater.

In one or more embodiments, the total amount of organosilicons bound to the surface of the silica are present in amounts from 2 weight percent to 14 weight percent based on the total weight of the silica.

In one or more embodiments, the polymer silica masterbatch can use a polyamide that is an either an amorphous polyamide or a crystalline polyamide, a high molecular weight polyamide or a low molecular weight polyamide, for example, Kevlar™ Nylon, Nylon 6, Nylon 6,6, or Nomex™.

In one or more embodiments, the polyurethane can be a high durometer polyurethane, a low durometer polyurethane, soluble polyurethanes or soluble foaming polyurethanes such as Urea.

In one or more embodiments, the natural rubber or synthetic polymer can be: a natural rubber latex, or a dry natural rubber derived from a natural rubber latex; a synthetic rubber latex, or a dry synthetic rubber derived from a synthetic rubber latex; a thermoplastic polymer latex, or a dry thermoplastic polymer derived from a thermoplastic polymer latex; and a resin polymer latex, or a dry resin polymer derived from a resin polymer latex; or combinations thereof.

The natural rubber latex can be a Guayule plant material, a Hevea plant material, or mixtures thereof.

The rubber latex can be a dry natural rubber derived from a natural rubber latex; the synthetic rubber latex, the dry synthetic rubber derived from a synthetic rubber latex; a polymer selected from the group consisting of a polymerized conjugated diene, a polymerized vinyl monomer, and combinations thereof.

The masterbatch can be used to create an article, such as a rubber tire.

While these embodiments have been described with emphasis on the embodiments, it should be understood that within the scope of the appended claims, the embodiments might be practiced other than as specifically described herein.

What is claimed is:

1. A functionalized silica used for blending styrene butadiene rubber with a polyamide or a polyurethane, wherein the functionalized silica comprises:
a. a total amount of at least two silanes, wherein the total amount of the at least two silanes is from 0.1 weight percent to 25 weight percent of the;
b. a first silane coupling agent and a second silane coupling agent simultaneously bond to an outer surface of the functionalized silica, and further comprises:
(i) the first silane coupling agent reacts with a polybutadiene; and
(ii) the second silane coupling agent reacts with a polyamide or a polyurethane, or combinations thereof, and wherein:
(a) the first silane coupling agent comprises:
1. an organosilicon derived from an organic silane having the structure: Z₁Z₂Z₃Si(CH₂)_{y}X(CH₂)_{y}SIZ₁Z₂Z₃, wherein X is a polysulfide, wherein y is an integer equal to or greater than 1; and wherein Z₁, Z₂, and Z₃ are each independently selected from the group consisting of: hydrogen, alkoxy, halogen, and hydroxyl: or
2. an organosilicon derived from an organic silane having the structure 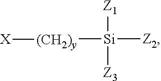
wherein:
a. X is a functional mercapto group;
b. Y is an integer equal to or greater than 0; and
c. Z₁, Z₂, and Z₃ are each independently selected from the group consisting of hydrogen, alkoxy, halogen, and hydroxyl, and combinations thereof; or
3. combinations of the two first silanes; wherein the organosilicons are present as an average tetrameric structure having a T.sup.3/T.sup.2 ratio of 0.75 or greater as measured by NMR;
(b) the second silane coupling agent for compatibilizing with the polyamide or the polyurethane consisting of an organosilane an organosilicon derived from an organic silane having the structure 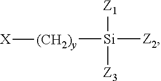
wherein:
1. X is a functional group selected from the group consisting of: an amino group, a polyamino alkyl group, a thiocyanato group, an epoxy group, or a halogen;
2. Y is an integer equal to or greater than 0; and
3. Z₁, Z₂, and Z₃ are each independently selected from the group consisting of hydrogen, alkoxy, halogen, and hydroxyl, and combinations thereof; and
4. wherein the first and second silane coupling agents have a T.sup.3/T.sup.2 ratio of 0.75 or greater as measured by NMR; and the blend of the silica and silanes form the functionalized silica.

2. The functionalized silica of claim 1, wherein each silane coupling agent is derived from an organosilane having three readily hydrolyzable groups attached directly to a silicon atom of the organosilane, and at least one organic group attached directly to the silicon atom.

3. The functionalized silica of claim 1, wherein the T.sup.3/T.sup.2 ratio is 0.9 or greater.

4. The functionalized silica of claim 1, wherein the total amount of the organosilicons bound to the surface of the silica are present in amounts from 2 weight percent to 14 weight percent based on the total weight of the silica.

5. A polymer silica masterbatch comprising:
a. 5.0 weight percent to 50 weight percent of a natural rubber or synthetic polymer;
b. 2.0 weight percent to 40 weight percent of a functionalized silica, wherein the silane coupling agents are chemically bound to the surface of the silica are present as an average tetrameric structure having a T.sup.3/T.sup.2 ratio of 0.75 or greater as measured by NMR; and
c. a member of the group consisting of:
(i) 5.0 weight percent to 50 percent of a polyamide selected from the group:
1. a dry polyamide; or
2. a latex emulsion of polyamide;
(ii) 5 weight percent to 50 weight percent of a polyurethane selected from the group:
1. a dry polyurethane; or
2. an emulsion (latex) of polyurethane; or
(iii) a mixture of the polyamide and polyurethane, wherein the polyamide to polyurethane is present in the mixture in a ratio between 1:20 polyamide to polyurethane to 20:1 polyamide to polyurethane, and wherein the functionalized silica bonds to both the polyamide, the polyurethane, or both while providing strong covalent bonding to the natural or synthetic polymer.

6. The polymer silica masterbatch of claim 5, wherein the functionalized silica has a T.sup.3/T.sup.2 ratio of 0.9 or greater.

7. The polymer silica masterbatch of claim 5, wherein the total amount of organosilicons bound to the surface of the silica are present in amounts from 2 weight percent to 14 weight percent based on the total weight of the silica.

8. The polymer silica masterbatch of claim 5, wherein each silane coupling agent is derived from an organosilane having three readily hydrolyzable groups attached directly to a silicon atom of the organosilicon, and at least one organic group attaches directly to the silicon atom.

9. The polymer silica masterbatch of claim 5, wherein the polyamide is an amorphous polyamide or a crystalline polyamide, a high molecular weight polyamide, or a low molecular weight polyamide.

10. The polymer silica masterbatch of claim 5, wherein the polyurethane can be a high durometer polyurethane, a low durometer polyurethane, soluble polyurethanes, or soluble foaming polyurethanes.

11. The polymer silica masterbatch of claim 5, wherein the natural rubber or synthetic polymer is:
a. a natural rubber latex or a dry natural rubber derived from a natural rubber latex;
b. a synthetic rubber latex or a dry synthetic rubber derived from a synthetic rubber latex;
c. a thermoplastic polymer latex or a dry thermoplastic polymer derived from a thermoplastic polymer latex; and
d. a resin polymer latex or a dry resin polymer derived from a resin polymer latex; or combinations thereof.

12. The polymer silica masterbatch of claim 11, wherein the natural rubber latex comprises Guayule plant material, Hevea plant material, or mixtures thereof.

13. The polymer silica masterbatch of claim 5, wherein the natural rubber or synthetic polymer is a polymer selected from the group consisting of: a polymerized conjugated diene, a polymerized vinyl monomer, and combinations thereof.

14. An article comprising the polymer silica masterbatch of claim 5.

15. A rubber tire comprising the polymer silica masterbatch of claim 5.
